(19) United States
(12) Patent Application Publication
(10) Pub. No.: US 2024/0249135 A1
(43) Pub. Date: Jul. 25, 2024

(54) METHOD FOR COMBINING CLASSIFICATION AND FUNCTIONAL DATA ANALYSIS FOR ENERGY CONSUMPTION FORECASTING

(71) Applicant: Hitachi, Ltd., Tokyo (JP)

(72) Inventors: Aniruddha Rajendra RAO, San Jose, CA (US); Chandrasekar VENKATRAMAN, Saratoga, CA (US); Chetan GUPTA, San Mateo, CA (US)

(21) Appl. No.: 18/100,933

(22) Filed: Jan. 24, 2023

(51) Int. Cl. G06N 3/08

(52) U.S. Cl. CPC G06N 3/08

(57) ABSTRACT

Example implementations described herein involve systems and methods that can include, for receipt of time-series data indicative of energy consumption associated with a type of building of a plurality of different types of buildings and a climatic zone from a plurality of climatic zones, executing random convolutional kernel (RCK) on the time-series data to generate a classification group of the time-series data according to type of building and the climatic zone; and executing a trained functional neural network (FNN) on the time-series data of the classification group to provide a short-term energy consumption forecast.

### BACKGROUND

### Field

The present disclosure is generally directed to energy consumption forecasting, and more specifically, systems and methods for combining classification and functional data analysis for energy consumption forecasting.

### Related Art

In the related art, there are implementations that involve univariate approaches that need to be learned for each instance and hence cannot be generalized, such as ARIMA, Exponential Smoothing (ES), and Prophet. Such related art methods do not make use of the existing patterns in the data leading to inaccurate forecasts.

Functional data analysis (FDA) has proven to be a great statistical approach to analyzing time-series data with patterns. Function-on-function linear models (FFLM) can be used to build the mathematical mapping for forecasting. Compared to Deep Learning (DL), as functional data modeling techniques, function-on-function linear models are more efficient in terms of capturing the rich information in time-series data (i.e., needing fewer parameters), less restrictive on data format (i.e., data can have different resolutions across samples), and less restrictive on the underlying mapping (i.e., the parameters can be different at different times within the considered time horizons). However, such a related art model can only handle linear relations. Energy consumption is a complex problem. Forecasts based on this linear model tend to generate inaccurate results.

### SUMMARY

It is an object of the present disclosure to forecast energy consumption based on business categories and climatic zones for accurate forecasting to enable pre-incident planning of optimal power shut-off during disasters (Typhoon, Hurricanes, Wildfire, etc.), which is a challenging problem. Accurate artificial intelligence (AI) forecasting models for multi-usage in different climatic condition is important for this scenario. Further, the re-use of forecasting models will be necessary for scalability.

Businesses have released products, services, and open-source software for time series forecasting. Several research papers have been published in the area of classification. However, there has not been any product or service that combines classification and functional data analysis-based forecasting, especially for building energy consumption. Further, the use case to use the technique for pre-incident grid resiliency contingency planning is unique.

In example implementations described herein, there is a novel two-step accurate short-term forecasting for energy consumption using Random Convolutional Kernels (RCK) and Functional Neural Network (FNN). In the present disclosure, short-term forecasting is defined to indicate day-ahead to week-ahead. Example implementations described herein introduce the first step (i.e. classification), using RCK. The energy consumption pattern depends on the building type and location. RCK takes advantage of the energy consumption pattern in the data to classify each building. After the first step, example implementations described herein have classified the data into similar buildings based on energy consumption patterns and location. This helps the example implementations described herein to make a generalized model for forecasting in the second step. Example implementations described herein involve a short-term forecasting model using FNN that makes use of the energy consumption pattern to give a superior forecast compared to the prior art.

Aspects of the present disclosure can involve a method, which can include, for receipt of time-series data indicative of energy consumption associated with a type of building of a plurality of different types of buildings and a climatic zone from a plurality of climatic zones, executing random convolutional kernel (RCK) on the time-series data to generate a classification group of the time-series data according to the type of building and the climatic zone; and executing a trained functional neural network (FNN) on the time-series data of the classification group to provide a short-term energy consumption forecast.

Aspects of the present disclosure can involve a computer program, which can include instructions involving, for receipt of time-series data indicative of energy consumption associated with a type of building of a plurality of different types of buildings and a climatic zone from a plurality of climatic zones, executing random convolutional kernel (RCK) on the time-series data to generate a classification group of the time-series data according to the type of building and the climatic zone; and executing a trained functional neural network (FNN) on the time-series data of the classification group to provide a short-term energy consumption forecast. The computer program and instructions can be stored in a non-transitory computer readable medium and executed by one or more processors.

Aspects of the present disclosure can involve a system, which can include, for receipt of time-series data indicative of energy consumption associated with a type of building of a plurality of different types of buildings and a climatic zone from a plurality of climatic zones, means for executing random convolutional kernel (RCK) on the time-series data to a generate classification group of the time-series data according to type of building and the climatic zone; and means for executing a trained functional neural network (FNN) on the time-series data of the classification group to provide a short-term energy consumption forecast.

Aspects of the present disclosure can involve an apparatus, which can include a processor, configured to, for receipt of time-series data indicative of energy consumption associated with a type of building of a plurality of different types of buildings and a climatic zone from a plurality of climatic zones, execute random convolutional kernel (RCK) on the time-series data to generate a classification group of the time-series data according to the type of building and the climatic zone; and execute a trained functional neural network (FNN) on the time-series data of the classification group to provide a short-term energy consumption forecast.

Aspects of the present disclosure can involve a method, which can include, for receipt of time-series data of a system, executing random convolutional kernel (RCK) on the time-series data to generate a classification group of the time-series data according to the data types associated with the system; and executing a trained functional neural network (FNN) on the time-series data of the classification group to provide a short-term forecast.

Aspects of the present disclosure can involve a computer program, which can include instructions involving, for receipt of time-series data of a system, executing random convolutional kernel (RCK) on the time-series data to generate a classification group of the time-series data according to the data types associated with the system; and executing a trained functional neural network (FNN) on the time-series data of the classification group to provide a short-term forecast. The computer program and instructions can be stored in a non-transitory computer readable medium and executed by one or more processors.

Aspects of the present disclosure can involve a system, which can include, for receipt of time-series data of a system, means for executing random convolutional kernel (RCK) on the time-series data to a generate classification group of the time-series data according to the data types associated with the system; and means for executing a trained functional neural network (FNN) on the time-series data of the classification group to provide a short-term forecast.

Aspects of the present disclosure can involve an apparatus, which can include a processor, configured to, for receipt of time-series data of a system, execute random convolutional kernel (RCK) on the time-series data to generate a classification group of the time-series data according to the data types associated with the system; and executing a trained functional neural network (FNN) on the time-series data of the classification group to provide a short-term forecast.

### BRIEF DESCRIPTION OF DRAWINGS

FIG. 1 illustrates an example of a flow diagram for the forecasted model, in accordance with an example implementation.

FIG. 2 illustrates a data processing using a window, in accordance with an example implementation.

FIG. 3 illustrates an example architecture of the Functional Neural Network (FNN), in accordance with an example implementation.

FIG. 4 illustrates an example comparison of different methods using root mean square error (RMSE) for 50 random buildings.

FIG. 5 illustrates an example comparison of different methods using RMSE for 50 random supermarket buildings.

FIG. 6 illustrates an example comparison of the random model and the supermarket model described in FIGS. 4 and 5 when the supermarket data is applied.

FIG. 7(A) illustrates a system involving a plurality of physical systems networked to a management apparatus, in accordance with an example implementation.

FIG. 7(B) illustrates an example set of data that can be collected from the physical systems, in accordance with an example implementation.

FIG. 8 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art of practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve a novel two-step short-term forecasting for energy consumption using Random Convolutional Kernels (RCK) and Functional Neural Network (FNN). The proposed system has the following components.

Data collection and data storage units: This component collects historical energy consumption data and building labels along with the location.

Data-driven classification model building units: This component utilizes RCK to classify different buildings based on energy consumption.

Data-driven forecasting model building units: This component utilizes the Functional Neural Network (FNN) to build a model that forecasts energy consumption.

Model deploying units: This component deploys the learned model on streaming data to produce and transmit real-time data-driven forecasts.

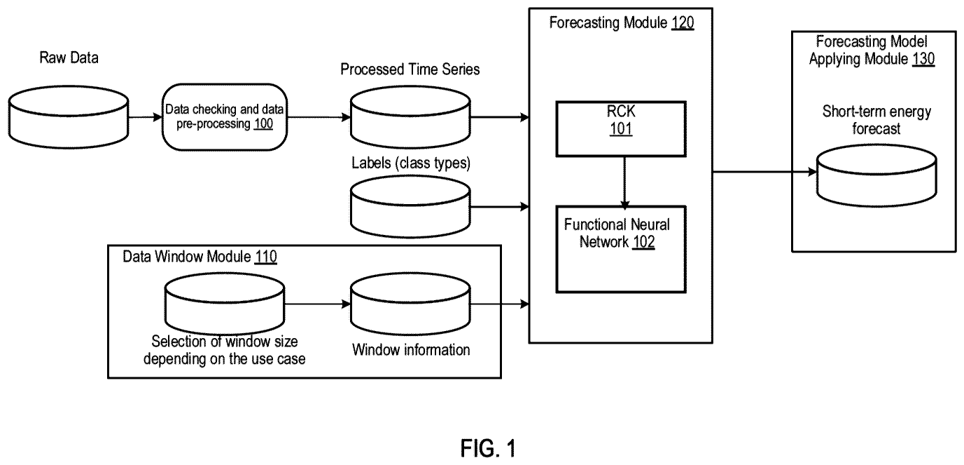

FIG. 1 illustrates an example of a flow diagram for the forecasted model, in accordance with an example implementation. In the present disclosure, the approach of FIG. 1 is used as an example implementation for forecasting the energy consumption of buildings.

The proposed data-driven approach can involve the following modules:

Data checking and data pre-processing module 100: This module aims to ensure that the energy consumption data to be used in the later calculation is regularly observed over time, (i.e., without big time gaps between adjacent observations). The module also checks for outliers and removes them if any.

Classification/RCK module 101: This module classifies the different buildings using the energy consumption information.

Data window module 110: In this module, the example implementations consider a window (e.g., daily/weekly) of the energy consumption information on which the forecasting model is applied depending on the use case.

Forecasting module 120: This module conducts the learning phase of the Functional Neural Network (FNN) 102 for forecasting with the help of the classification defined in the RCK module 101 and the data from data window module 110.

Forecasting model applying module 130: This module conducts the applying phase of the learned forecasting model in data window module 110.

With respect to data checking and data pre-processing module 100, there are a few steps involved in this module 100 that are necessary to perform before the data is used as an input to these Machine Learning (ML) and Deep Learning (DL) algorithms. These relevant data preparation steps are performed on the input data before it is pushed into these algorithms. The example implementations are not restricted to any specific data preparation method.

Examples of data checking and data pre-processing steps include, but are not limited to, noise/outlier removal, missing data imputation, and so on. Once data is prepared it is further divided into training and testing sets. The training set is used during the model training phase, while the testing set is used for evaluating the model.

Some mathematical notations are defined below for the present disclosure. Suppose that the number of buildings is N. For each of the building, energy consumption data is observed within time range T. Let the observed data be defined using X_{i,j}((t_{i,j}), with t_{i,j}∈T for j=1, . . . , M. Example implementations involve labels (Yi) of the building type for each building and location.

Classification/RCK module 101 completes the first step in the analysis by using RCK to classify the buildings using the energy consumption information based on their usage patterns and location. The classification/RCK module 101 goes through the following steps. In the first step, RCK transforms the energy consumption time-series information using a large number of random convolutional kernels (i.e., kernels with random length, weights, bias, dilation, and padding). These kernels have randomly selected lengths from {7, 9, 11} with equal probability, making kernels considerably shorter than input time series in most cases. Each kernel is applied to each input time series, producing a feature map. The convolution operation involves a sliding dot product between a kernel and an input time series. In the second step, the transformed features are used to train a linear classifier. RCK is very effective when used in conjunction with linear classifiers (which have the capacity to make use of a small amount of information from each of a large number of features).

Data window module 110: the data is prepared to be processed for forecasting. Example implementations use the window approach on each building where one interval (e.g., day/week/month/year) of the data is considered to forecast for the next interval.

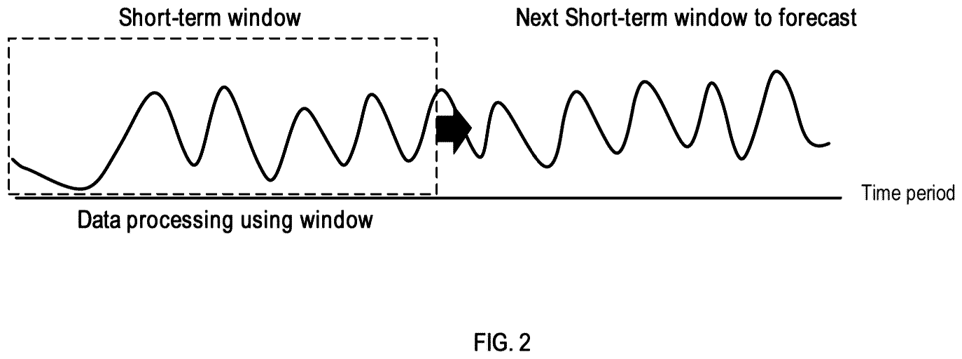

FIG. 2 illustrates a data processing using a window, in accordance with an example implementation. The example implementations slide the window by the interval time period until the end is reached as shown in FIG. 2. Basically, example implementations attempt to map X_{i,j}(t_{i,j}) to X_{i,j}(t_{i,j}′), where i=1, . . . . N, j=1, . . . , k (k<M) and j′=(k+1), . . . , (2k).

Forecasting module 120 uses the data from data window module 110 to feed it into the Functional Neural Network (FNN) 102 to get the forecast for the energy consumption. FNN identifies the underlying patterns in the data to make the forecast.

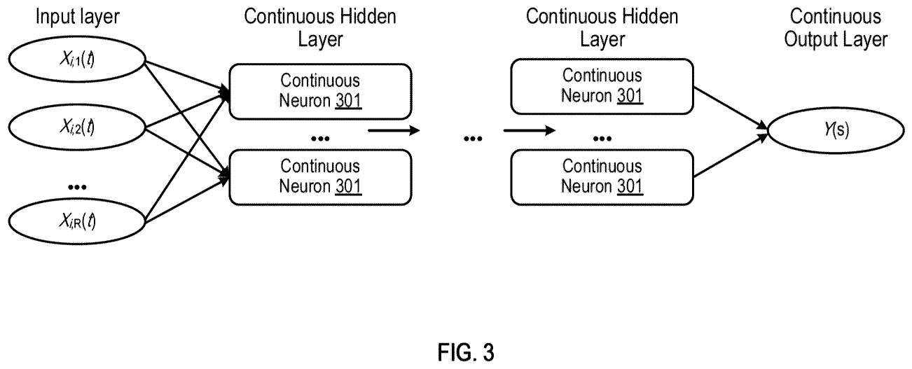

FIG. 3 illustrates an example architecture of the Functional Neural Network (FNN), in accordance with an example implementation. The forecasting module 120 takes advantage of the Neural Network architecture as illustrated in FIG. 3 to find complex relations in these patterns. The example implementations apply this method to each building group using the classification learned in the Classification/RCK module 101.

A Functional Neural Network 102 involves continuous neurons 301 which make up the continuous hidden layers. The l^{th} continuous hidden layer and k^{th} continuous neuron is defined as follows,

$${H}_{( k )}^{( l )} ( s ) = σ ( {b}_{( k )}^{( l )} ( s ) + {\sum }_{j = 1}^{l} \int {w}_{( j , k )}^{( i )} ( s , t ) {H}_{( j )}^{( i - 1 )}$$

(t)dt) where σ is the activation function, h₍ₖ₎^{(l)}(s) is the parameter function and w_{(j,k)}⁽ⁱ⁾(s, t) is the bivariate parameter function. Using the defined continuous neurons 301, example implementations can complete the forward propagation, and the partial derivatives can be computed to update the parameter functions in the back-propagation step. The example implementations go back and forth with the forward and backward propagation until a stopping criterion is reached. FNN 102 also has the flexibility to consider other functional features such as temperature (for this use case) if needed to improve the forecasting for the energy consumption.

The forecasting model applying module 130 involves the following steps when applying the learned model for energy consumption data. In the first step, the forecasting model applying module 130 classifies the new building. The forecasting model applying module 130 utilizes the model learned in the classification/RCK module 101 to classify each new building into the correct building type using the energy consumption patterns and location information. In the next step, the forecasting model applying module 130 calculates the forecast through forward propagation: by supplying the window energy consumption data of each building to the correct subtype model of the FNN 102. Example implementations obtain the forecast by feeding this information to the found parameters for FNN 102.

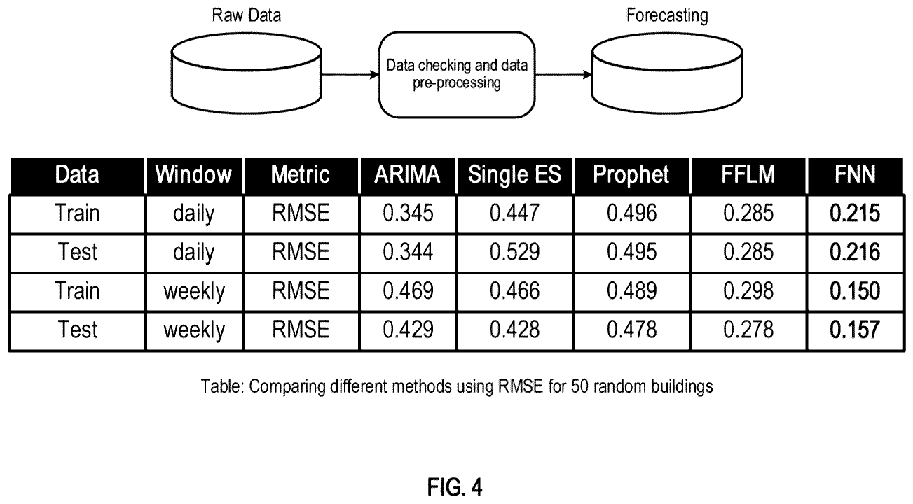

FIG. 4 illustrates an example comparison of different methods using root mean square error (RMSE) for 50 random buildings. RMSE is an absolute error measure that squares the deviations to keep the positive and negative deviations from canceling each other out. The data set used involves buildings across the United States from which 50 random samples are selected, and electricity is consumed in kW hourly for each hourly timepoint in a year. 80% of the data is used for training, and 20% of the data is used for testing. The functional samples can be considered daily or weekly. Specifically, FIG. 4 illustrates a table indicating if the data is training data or testing data, whether the window is daily or weekly, and the corresponding RMSE on a sample set of 50 random buildings without classification. The RMSE for training is the error in the model learning phase whereas the RMSE for testing is the error in the application phase. Based on the test data, the FNN has the lowest RSME score for both the training (e.g., learning the model) and the testing (e.g., forecasting).

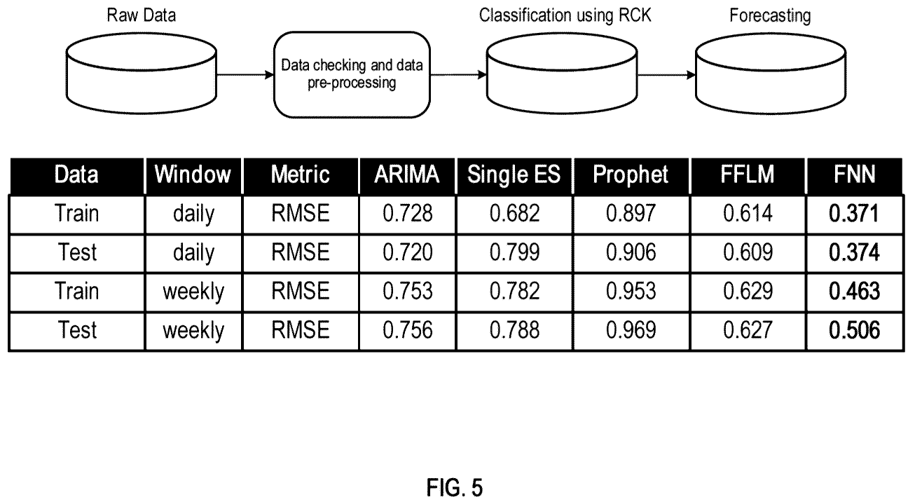

FIG. 5 illustrates an example comparison of different methods using RMSE for 50 random supermarket buildings. In the example implementation of FNN as illustrated in FIG. 5, the data set used is the same as FIG. 4, only that buildings are classified by using RCK, and 50 of the buildings classified as supermarkets are used to build a forecasting model for the supermarkets by using FNN. Based on the test data, the FNN has the lowest RSME score for both the training (e.g., learning the model) and the testing (e.g., forecasting).

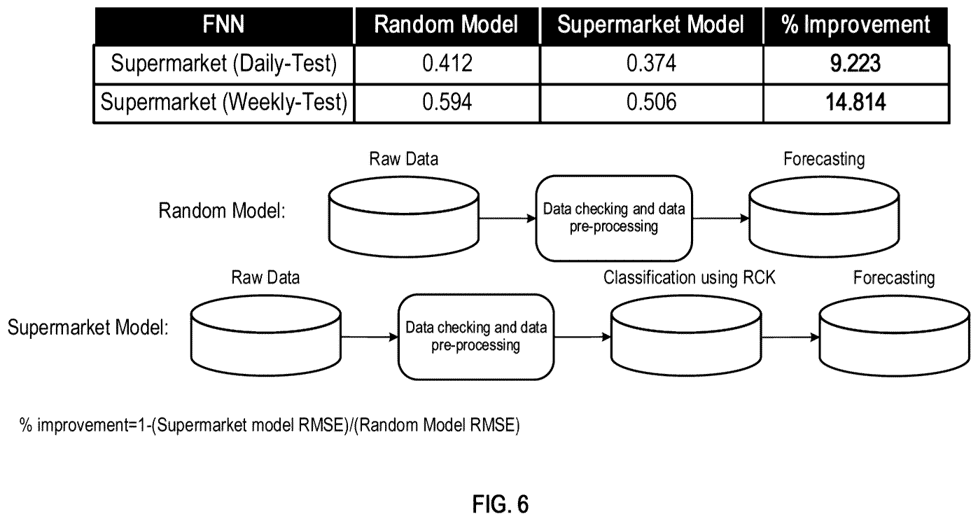

FIG. 6 illustrates an example comparison of the random model and the supermarket model described in FIGS. 4 and 5 when the supermarket data is applied. Specifically, in FIG. 6, the test set for the supermarket is applied to both the random building model (without classification) and the specifically trained supermarket model. As illustrated in FIG. 6, an improvement is shown at both the daily level and the weekly level when using the RCK and FNN technique to train a specific model for the specific type of building (supermarket) in comparison to using FNN to learn a model from random buildings.

Although the example implementations described herein were described with respect to constructing specialized models based on the type of building, other pertinent data can be used, and the present disclosure is not limited thereto. For example, climatic zones (e.g., temperate, tropical, desert, etc.) can also be used to classify buildings due to its effect on energy consumption patterns at various times of the year. Multiple classifications can also be used (e.g., building type+climatic zone) if desired for constructing the specialized models through the RCK and FNN processes described herein.

Through the example implementations described herein, the proposed two step forecasting can achieve the following advantages. The proposed system automatically considers the energy consumption patterns and location information to make the overall forecasting. The proposed system considers data factors and domain expert's opinions when performing classification and forecasting. The example implementations described herein can be capable of modeling complex correlations existing in the energy consumption patterns. The superiority of the proposed system can be demonstrated by real world data analysis.

The proposed forecasting approach is valuable in various scenarios. For example, the example implementations described herein can benefit a wide range of industries where the energy consumption varies based on energy pattern and location.

Power grid resiliency is a big issue faced globally. When disasters (Typhoons, Hurricanes, Wildfires) happen, the typical response is done after or during the occurrence. Pre-incident contingency plans can reduce the overall impact of customer black-outs and infrastructure damage. Further, by using accurate energy consumption forecasting, it is possible to reduce impact through ‘optimal load shedding’ and ‘power shutdown’ by developing a contingency plan before the arrival of the disaster.

Example implementations described herein can be useful for any situation where forecasting of future values based on classification and periodic variations. Examples of these are for disruptions in supply chain, equipment or labor failures, natural disaster to processes, and so on. It could also be used for future planning when the actual event information is available.

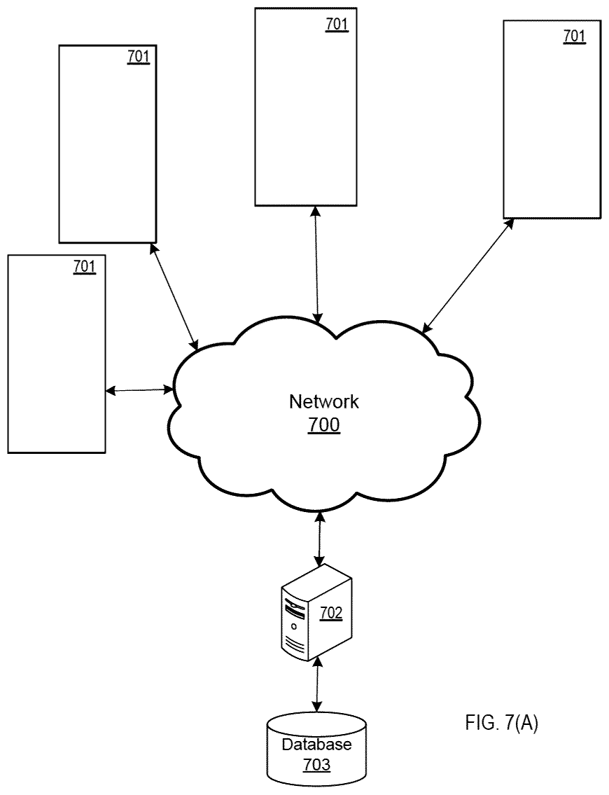

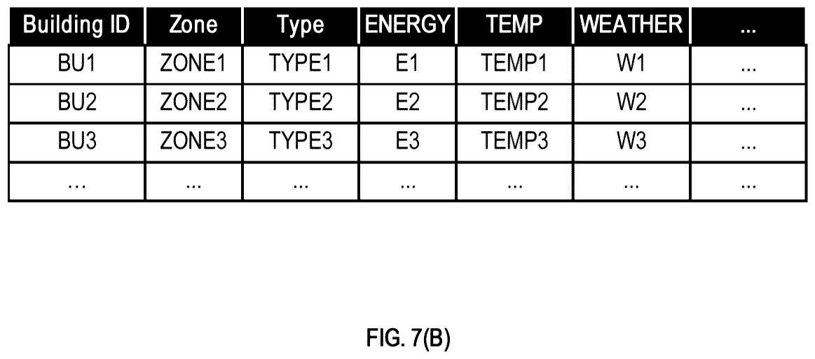

FIG. 7(A) illustrates a system involving a plurality of physical systems (e.g., as integrated into buildings) networked to a management apparatus, in accordance with an example implementation. One or more physical systems 701 integrated with various sensors are communicatively coupled to a network 700 (e.g., local area network (LAN), wide area network (WAN)) through the corresponding network interface of the sensor system installed in the physical systems 701, which is connected to a management apparatus 702. The management apparatus 702 manages a database 703, which contains historical data collected from the sensor systems from each of the physical systems 701. In alternate example implementations, the data from the sensor systems of the physical systems 701 can be stored in a central repository or central database such as proprietary databases that intake data from the physical systems 701, or systems such as enterprise resource planning systems, and the management apparatus 702 can access or retrieve the data from the central repository or central database. The sensor systems of the physical systems 701 can include any type of sensors to facilitate the desired implementation, such as but not limited to energy consumption (e.g., in time series format), weather data, temperature, and so on in accordance with the desired implementation.

In example implementations described herein, the management apparatus 702 may deploy one or more machine learning models such as the model ensemble described herein to intake sensor data from the physical systems 701. Depending on the analysis from the machine learning models, management apparatus 702 may control one or more physical systems 701 accordingly. For example, if the analysis indicates that one of the physical systems 701 needs to be shut down or reoriented, management apparatus 702 may control such a physical system to be shut down, reconfigured, or reoriented in accordance with the desired implementation.

FIG. 7(B) illustrates an example of management information that can be stored in a database 703, in accordance with an example implementation. Examples of data that can be utilized can involve building identifier (ID) to identify the building, and class labels such as the zone to indicate the climatic zone that the building is located in geographically (e.g., temperate, desert, etc.), type of building (e.g., office building, supermarket, etc.), as well as time-series data such as energy consumption (e.g., as time-series data across a period of time), outdoor temperature (e.g., as time series data), weather information (e.g., rain, snow, etc. as time-series data), and so on.

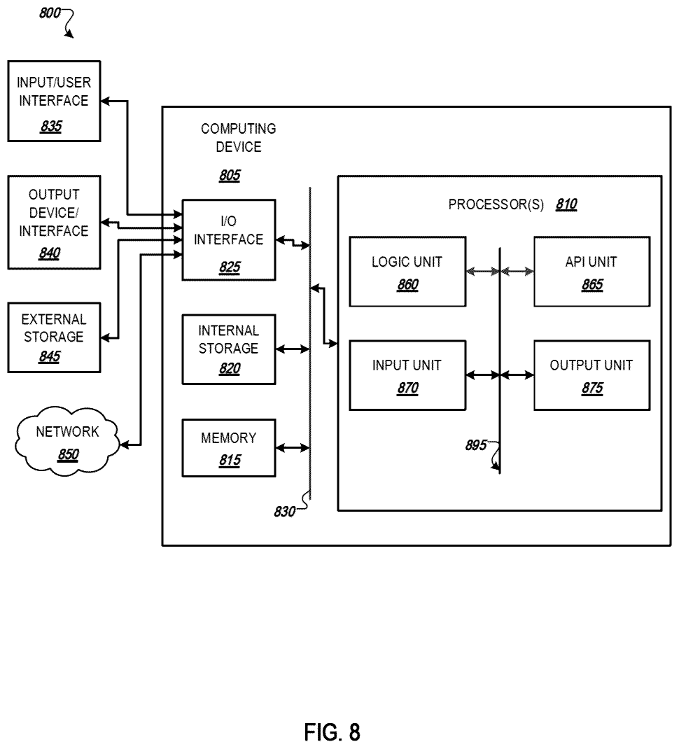

FIG. 8 illustrates an example computing environment with an example computer device suitable for use in some example implementations, such as a management apparatus 702 as illustrated in FIG. 7(A). Computer device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configurations. Computer device 805 or any connected computer device can be functioning as, providing services of, or referred to as a server, client, thin server, general machine, special-purpose machine, or another label.

I/O interface 825 can include but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, a satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in the example implementations.

Processor(s) 810 can be configured to execute a method or computer instructions, which can involve, for receipt of time-series data indicative of energy consumption associated with a type of building of a plurality of different types of buildings and a climatic zone from a plurality of climatic zones (e.g., as described in FIG. 7(B)), executing random convolutional kernel (RCK) 101 on the time-series data to generate a classification group of the time-series data according to the type of building and the climatic zone; and executing a trained functional neural network (FNN) 102 on the time-series data of the classification group to provide a short-term energy consumption forecast. The time length of the short-term energy consumption forecast can dependent on the expected length of a natural disaster. For example, daily can be used to forecast for the duration of a typical disaster such as a typhoon, cyclone, earthquake, wildfire events, and so on, or weekly for disasters such as forest fires, blizzards, flooding, and so on. As described with respect to FIGS. 4 to 6, through the example method or computer instructions as described herein, the accuracy of the trained FNN models can be improved on in comparison to the related art.

Processor(s) 810 can be configured to execute the method or instructions as described above, wherein the FNN can involve a plurality of continuous layers trained to map time-series data derived functions related to the different types of buildings and the plurality of climatic zones to a short-term energy consumption forecast model configured to provide the short-term energy consumption forecast as described with respect to FIGS. 1 to 3.

Depending on the desired implementation, the RCK 101 is configured to generate the classification according to the type of building and the climatic zone from a database of class labels as illustrated in FIG. 7(B) is used to generate different classes based on class labels, wherein the FNN is trained for each of the class labels as described with respect to FIGS. 1 and 3.

As illustrated in FIG. 2, the short-term forecast can be based on a selected time window from a plurality of time windows (e.g., daily, weekly, hourly, etc.). Accordingly, the FNN can be trained across the plurality of time windows as set (e.g., trained against daily, weekly, etc.) as illustrated in FIGS. 4 to 6. As illustrated in FIG. 2, the time-series data and the short-term energy forecast can be represented as periodic functions.

As illustrated in FIG. 7(B), the time series-data comprises can involve one or more of temperature-time series data or other weather time-series data such as humidity time-series data or any other time series data that can be useful in accordance with the desired implementation. Examples of time-series data that can be used can involve precipitation time-series data, or vehicle count time-series data regarding the vehicle count for the building associated with the time-series data.

Depending on the desired implementation, the example implementations can be extended to any other type of sensor system besides those for buildings to do sensor data forecasting. For example, processor(s) 810 can be configured to execute a method or computer instructions, which can involve, for receipt of time-series data for a type of sensor from a plurality of types of sensors as illustrated in FIG. 7(A), executing random convolutional kernel (RCK) 101 on the time-series data to generate a classification group of the time-series data according to the type of sensor; and executing a trained functional neural network (FNN) 102 on the time-series data of the classification group to provide a short-term sensor data forecast.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing.” “computing.” “calculating,” “determining,” “displaying,” or the like can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of time-series data indicative of energy consumption associated with a type of building of a plurality of different types of buildings and a climatic zone from a plurality of climatic zones:
executing random convolutional kernel (RCK) on the time-series data to generate a classification group of the time-series data according to the type of building and the climatic zone; and
executing a trained functional neural network (FNN) on the time-series data of the classification group to provide a short-term energy consumption forecast.

2. The method of claim 1, wherein the FNN comprises a plurality of continuous layers trained to map time-series data derived functions related to the different types of buildings and the plurality of climatic zones to a short-term energy consumption forecast model configured to provide the short-term energy consumption forecast.

3. The method of claim 2, wherein the RCK is configured to generate the classification group according to the type of building and the climatic zone from a database of class labels used to generate different classes based on class labels, wherein the FNN is trained for each of the class labels.

4. The method of claim 1, wherein the short-term energy consumption forecast is based on a selected time window from a plurality of time windows.

5. The method of claim 4, wherein the FNN is trained across the plurality of time windows.

6. The method of claim 1, wherein the time-series data and the short-term energy consumption forecast are represented as periodic functions.

7. The method of claim 1, wherein the time-series data comprises one or more of temperature time-series data, humidity time-series data, precipitation time-series data, or vehicle count time-series data.

8. A non-transitory computer readable medium, storing instructions for executing a process comprising:
for receipt of time-series data indicative of energy consumption associated with a type of building of a plurality of different types of buildings and a climatic zone from a plurality of climatic zones:
executing random convolutional kernel (RCK) on the time-series data to generate a classification group of the time-series data according to the type of building and the climatic zone; and
executing a trained functional neural network (FNN) on the time-series data of the classification group to provide a short-term energy consumption forecast.

9. The non-transitory computer readable medium of claim 8, wherein the FNN comprises a plurality of continuous layers trained to map time-series data derived functions related to the different types of buildings and the plurality of climatic zones to a short-term energy consumption forecast model configured to provide the short-term energy consumption forecast.

10. The non-transitory computer readable medium of claim 9, wherein the RCK is configured to generate the classification group according to type of building and the climatic zone from a database of class labels used to generate different classes based on class labels, wherein the FNN is trained for each of the class labels.

11. The non-transitory computer readable medium of claim 8, wherein the short-term energy consumption forecast is based on a selected time window from a plurality of time windows.

12. The non-transitory computer readable medium of claim 11, wherein the FNN is trained across the plurality of time windows.

13. The non-transitory computer readable medium of claim 8, wherein the time series-data and the short-term energy consumption forecast are represented as periodic functions.

14. The non-transitory computer readable medium of claim 8, wherein the time series-data comprises one or more of temperature time-series data, humidity time-series data, precipitation time-series data, or vehicle count time-series data.

15. An apparatus, comprising:
a processor, configured to:
for receipt of time-series data indicative of energy consumption associated with a type of building of a plurality of different types of buildings and a climatic zone from a plurality of climatic zones:
execute random convolutional kernel (RCK) on the time-series data to generate a classification group of the time-series data according to the type of building and the climatic zone; and
execute a trained functional neural network (FNN) on the time-series data of the classification group to provide a short-term energy consumption forecast.
